(19) United States
(12) Patent Application Publication
(10) Pub. No.: US 2006/0183627 A1
(43) Pub. Date: Aug. 17, 2006

(54) Method for regenerating re2o7 doped catalyst supports

(75) Inventors: Jurgen Stephan, Mannheim (DE); Markus Schubert, Ludwigshafen (DE); Christian Weichert, Bad Durkheim (DE); Wilhelm Ruppel, Mannheim (DE); Peter Resch, Hettenleidelheim (DE); Soeren Zimdahl, Schriesheim (DE); Frank Mrzena, Mutterstadt (DE); Andreas Molitor, Seeheim-Jugenheim (DE); Stefan Berg, Frankenthal (DE); Mathias Fohrmann, Ludwigshafen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/547,293

(22) PCT Filed: Feb. 16, 2004
(86) PCT No.: PCT/EP04/01428

§ 371 Date: Aug. 30, 2005

(30) Foreign Application Priority Data
Mar. 3, 2003 (DE) 103 09 070.3

(51) Int. Cl. B01J 38/12

(52) U.S. Cl. 502/38

(57) ABSTRACT

Method of regenerating an Re₂O₇-doped supported catalyst which has been deactivated by use in the metathesis of a hydrocarbon mixture comprising C₂-C₆-olefins (C₂₋₆⁼ feed) (deactivated catalyst), which comprises
treating the deactivated catalyst with an inert gas (regeneration gas K1) at from 400 to 800° C. and
subsequently treating the deactivated catalyst which has been pretreated with regeneration gas K1 with an oxygen-containing gas (regeneration gas K2).

The present invention relates to a method of regenerating an Re₂O₇-doped supported catalyst which has been deactivated by use in the metathesis of a hydrocarbon mixture comprising C₂-C₆-olefins (C₂₋₆⁼ feed) (deactivated catalyst), which comprises
treating the deactivated catalyst with an inert gas (regeneration gas K1) at from 400 to 800° C. and
subsequently treating the deactivated catalyst which has been pretreated with regeneration gas K1 with an oxygen-containing gas (regeneration gas K2).

C₂-C₆-Olefins are important basic chemicals in the value-added chain leading to the synthesis of complex chemical compounds. Since they are not always obtained in the desired ratios by generally known production processes, metathesis offers a frequently utilized way of converting them into one another.

A particularly important metathesis catalyst is Re₂O₇. Its advantages are the low temperature at which rhenium displays metathesis activity, the low isomerization rate which is often desirable in reactions in which no double bond isomerization is wanted and the essentially simple regeneration by burning-off using O₂-containing gases.

However, such catalysts are deactivated relatively quickly because deposits of, inter alia, relatively high molecular weight hydrocarbon compounds are formed on them. For this reason, they regularly have to be brought back to an active state by means of a suitable regeneration procedure. This is usually carried out by burning off the deposits on the catalyst by means of O₂ or O₂-containing gas mixtures.

Regeneration methods are described in U.S. Pat. No. 3,365,513, EP 933 344, U.S. Pat. No. 6,281,402, U.S. Pat. No. 3,725,496, DE 32 29 419, GB 1144085, U.S. Pat. No. 3,726,810, BE 746,924 and DE 3427630.

In all these patent applications, the metathesis catalyst is regenerated by burning-off in air.

An in-principle problem always associated with the regeneration procedure for a metathesis catalyst is the highly exothermic nature of these burn-off processes. Furthermore, damage may be expected if the catalyst is subjected to excessively rapid burn-off, in particular when the temperature in the burn-off procedure exceeds 650° C. These high-temperature hot spots in the reactor can mechanically damage the catalyst material and can also have adverse effects on the stability of the reactor material if the design temperature is exceeded due to the high liberation of energy in the large, often adiabatically operated reactors.

Although it is possible to avoid the high temperatures if the gas mixture has a low O₂ content of, for example, from 0.5 to 4% by volume, this makes the process time-consuming and energy intensive.

Countermeasures for preventing damage to the catalyst by high temperatures in the regeneration procedure are indicated, for example, in U.S. Pat. No. 4,072,629, in which a catalyst which has been deactivated in the metathesis of olefins having more than 12 carbon atoms is firstly pretreated with a mixture of olefins having 2-12, preferably 2-5, carbon atoms at 50-350° C.

DE 1955640 describes a regeneration procedure in which the metathesis catalyst is firstly heated to 200° C. under nitrogen, subsequently heated from 200 to 580° C. (24 K/h) in air over 16 hours and then has to be roasted in air for another 24 hours. The very slow heating rate of 24 K/h has to be chosen because there would otherwise be a risk of runaway reactions as a result of the large amount of organic material present. Owing to the low heating rate, the overall regeneration process takes quite a long time.

It is an object of the present invention to provide a regeneration method for Re-containing catalysts which have been deactivated in the metathesis of olefins. This regeneration method should firstly avoid the risk of damage to the catalyst by excessively high temperatures but also proceed relatively quickly so that long downtimes of the catalyst and the reactor which is equipped with the catalyst are avoided.

We have found that this object is achieved by the method defined at the outset.

The catalysts which can be regenerated by the method of the present invention are customary Re₂O₇-doped supported catalysts. They are preferably composed of rhenium oxide on gamma-aluminum oxide or on Al₂O₃/B₂O₃/SiO₂ mixed supports. In particular, Re₂O₇/gamma-Al₂O₃ having a rhenium oxide content of from 1 to 20% by weight, preferably from 3 to 15% by weight, particularly preferably from 6 to 12% by weight, is used as catalyst. The preparation of such catalysts is described, for example, in DE 19837203, GB 1105564, U.S. Pat. No. 4,795,534 and DE 19947352.

Furthermore, the Re₂O₇-doped supported catalyst can be modified by transition metal compounds, for example in the form of transition metal oxides or halides, especially by addition of oxides or halides of molybdenum (as described in U.S. Pat. No. 3,702,827) or of niobium or tantallum (as described in EP-A-639549). Additions from the group of alkali metals or alkaline earth metals are also able to modify the Re₂O₇-containing catalysts in an advantageous way (as described in EP-A-639549).

The deactivation of the catalysts requiring regeneration generally occurs as a result of the C₂₋₆⁼ feed being passed in the liquid phase through a catalyst bed of a freshly prepared or regenerated Re₂O₇-doped supported catalyst at from 10 to 150° C., preferably from 20 to 80° C., and a pressure of from 10 to 100 bar, preferably from 5 to 30 bar, at a flow rate of from 0.1 to 1000, preferably from 1 to 15, liters per kg per hour. The catalyst is subsequently separated from the C₂₋₆⁼ feed and the products formed in the metathesis. In the interests of simplicity, the separation is carried out by de-pressurizing the reactor in which the metathesis has been carried out to atmospheric pressure and, if appropriate, taking off liquid reaction mixture still present from the reactor.

The C₂₋₆⁼ feed is generally a hydrocarbon mixture consisting essentially of C₂-C₆-olefins, preferably a mixture comprising mainly 1- or 2-butene (referred to as C₄-olefin mixtures) and possibly also ethylene. The C₂₋₆⁼ feed usually comprises no more than 30% of olefins having 12 and more carbon atoms.

The C₄-olefin mixtures are fractions which are also referred to as raffinate II and are obtained in refineries in fuel production or various processes for cracking butane, naphtha or gas oil.

The raffinate II can be prepared, for example, by
subjecting naphtha or some other hydrocarbon compound to a steam cracking process or FCC process (fluid catalytic cracking process) and taking off a C₄-hydrocarbon fraction from the stream formed,
producing a C₄-hydrocarbon stream consisting essentially of isobutene, 1-butene, 2-butene and butanes (raffinate I) from the C₄-hydrocarbon fraction by selectively hydrogenating the butadienes and butynes to butenes or butanes or removing the butadienes and butynes by extractive distillation, and
separating off the major part of the isobutene from the raffinate I by chemical, physicochemical or physical methods (cf., in particular, the BASF isobutene process which is described in EP-A 0 003 305 and EP-A 0 015 513) to give a raffinate II.

Further methods of preparing C₄-olefin mixtures are generally known and described, for example, in DE-A-10160726.

If the C₂₋₆⁼ feed comprises oxygen compounds, the C₂₋₆⁼ feed comprising oxygen compounds is usually freed of the oxygen compounds before it is used in the metathesis. This is advantageously achieved by freeing a C₂₋₆⁼ feed comprising oxygen compounds of the oxygen compounds by passing it though a guard bed. Preference is given to using molecular sieves, for example zeolites such as 3 Å and NaX molecular sieves (13×), as guard bed. The purification is carried out in adsorption towers at temperatures and pressures which are chosen so that all components are present in the liquid phase.

If the metathesis reaction is carried out using such feeds, the deactivation of the catalysts is usually caused by deposits of relatively high molecular weight hydrocarbon compounds which are solid under normal conditions forming on the catalyst surface.

The regeneration of the deactivated catalyst is carried out in two stages.

In the first stage, the deactivated catalyst is treated with an inert gas (regeneration gas K1) at from 400 to 800° C.

The regeneration gas K1 is usually a gas which is selected from the group consisting of nitrogen, noble gases and gas mixtures of nitrogen and noble gases and may comprise up to 10% of CO₂ or up to 40% of a saturated C₁-C₆-hydrocarbon.

The regeneration gas used is preferably a mixture consisting essentially of
from 50 to 100% of a gas selected from the group consisting of nitrogen, noble gases and gas mixtures of nitrogen and noble gases,
if desired, up to 0.1% of oxygen and
if desired, up to 10% of CO₂ or up to 40% of a saturated C₁-C₆-hydrocarbon. Particular preference is given to using nitrogen as regeneration gas K1.

The regeneration gas K1 is preferably passed at a gas space velocity of from 10 to 500 liters per kg per hour through a catalyst bed of the deactivated catalyst. During this treatment, the gas temperature is preferably increased at a rate of from 50 to 100° C./h from an initial gas temperature of 40-150° C.

The treatment of the deactivated catalyst with regeneration gas K1 is usually continued until the formation of CO₂ and CO has largely stopped, i.e. the sum of the concentrations of the two gases in the gas leaving the catalyst bed (regeneration offgas K1) is not more than 500 ppm by weight.

After conclusion of stage 1, stage 2 of the regeneration is commenced. In this, the deactivated catalyst which has been pretreated with regeneration gas K1 is treated with a gas mixture consisting of an oxygen-containing gas (regeneration gas K2).

The regeneration gas K2 is preferably pure oxygen or a mixture consisting essentially of
from >0.1 to 100% of oxygen,
from 50 to 99.9% of a gas selected from the group consisting of nitrogen, noble gases and gas mixtures of nitrogen and noble gases and
if desired, up to 10% of CO₂ or up to 40% of a saturated C₁-C₆-hydrocarbon.

The regeneration gas K2 is advantageously passed at a gas space velocity of 50-500 liters per kg per hour through a catalyst bed of the deactivated catalyst which has been pretreated with regeneration gas K1. The temperature of the regeneration gas K2 is generally 350-550° C.

The treatment of the deactivated catalyst which has been pretreated with regeneration gas K1 with the regeneration gas K2 is continued until the oxygen content of the regeneration gas K2 undergoes virtually no further change during the treatment. This means that the difference in the oxygen contents of the regeneration gas K2 used and the gas leaving the catalyst bed (regeneration offgas K2) is not more than 500 ppm by weight.

The regeneration of the deactivated catalyst (regeneration phase K) and the metathesis which causes deactivation of the catalyst (metathesis phase) are advantageously carried out alternately in a reactor.

If the metathesis is to be carried out effectively continuously and without interruption, the metathesis phase and the regeneration phase K are carried out simultaneously by providing a system of reactors, e.g. two, three or more, and carrying out the regeneration phase K in one reactor while the metathesis phase is carried out in another reactor. If the system of reactors comprises three or more reactors, it is advantageous to choose the reactor which has been in the metathesis phase for the longest time for the change of a reactor from the metathesis phase to the regeneration phase K.

The regeneration of the molecular sieves for removing the oxygen compounds from the C₂₋₆⁼ feed supplied to the reactors operating in the metathesis phase can advantageously be included in the method of regenerating the catalyst.

The reactors which are in the metathesis phase are advantageously preceded by a guard bed, e.g. in the form of an adsorption tower, in which removal of the oxygen compounds from the C₂₋₆⁼ feed occurs. While the C₂₋₆⁼ feed comprising oxygen compounds is passed through the adsorption tower, it is in the adsorption phase.

The molecular sieves require regeneration from time to time. For this purpose, the C₂₋₆⁼ feed is firstly removed from the guard bed. In the regeneration phase M, the deactivated molecular sieves are subsequently treated with an inert gas (regeneration gas M1) at flow rates of 1-2000 l/(kg*h) and a temperature of from 100 to 350° C. for 12-48 hours (regeneration phase M1) and, if desired, the deactivated molecular sieves which have been pretreated with inert gas are subsequently treated with an oxygen-containing gas mixture (regeneration gas M2) at flow rates of 1-2000 l/(kg*h) for 12-48 hours. This is preferably achieved, as in the regeneration of the reactors, by passing the appropriate gas streams into the adsorption tower.

In a preferred embodiment of the method, the gases which leave the reactors or adsorption towers undergoing regeneration (regeneration offgases) are utilized, in a heat exchange process, for heating the regeneration gases or constituents thereof to the required temperature.

In order to avoid interrupting the continuity of the metathesis, it is therefore advantageous to provide a system of adsorption towers, e.g. two, three or more, and to carry out the regeneration phase M in an adsorption tower while another adsorption tower is in the adsorption phase.

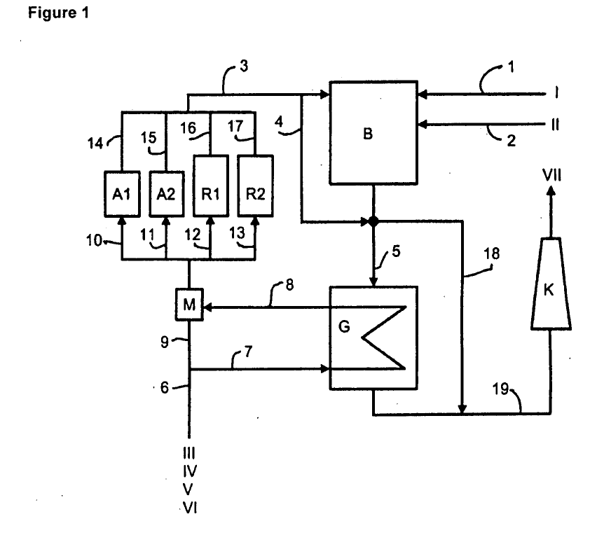

FIG. 1 schematically shows an apparatus comprising
two reactors (R1 and R2) in which the metathesis phase and regeneration phase K are carried out alternately, with one reactor being in the metathesis phase and the other reactor being in the regeneration phase,
two adsorption towers (A1 and A2) containing molecular sieves for removing the oxygen compounds from the C₂₋₆⁼ feed,
a combustion chamber B,
a gas preheater G configured as a heat exchanger and
a mixer M

by means of which a particularly preferred embodiment of the method of the present invention can be carried out.

In B, a hot gas is generated by combustion of natural gas (I) and air (II) which are introduced into the combustion chamber via the lines 1 and 2. A hot gas is additionally introduced into B via line. 3. This hot gas is alternatively the offgas from R1, R2, A1 or A2 which is formed in the regeneration of the catalyst or the molecular sieves (regeneration offgas). However, part or all of the regeneration offgas can also be introduced directly into G via lines 4 and 5. The gases formed in B or the regeneration offgases fed directly into B are conveyed together as heating gas via line 5 into G.

The required regeneration gas K1 (III), regeneration gas K2 (IV) or regeneration gas M1 (V) and regeneration gas M2 (VI) is firstly conveyed through line 6 and divided into two substreams. One substream is conveyed via line 7 into G in which it is heated and from there conveyed via line 8 into M. The second substream is conveyed via line 9 directly into M and mixed with the other substream there. The desired temperature of the respective regeneration gas can be set by appropriate metering of the cold and heated substreams. The respective regeneration gas is introduced via one of the lines 10, 11, 12 and 13 into the reactor or adsorption tower requiring regeneration. The regeneration offgas formed in the regeneration of the respective reactor or adsorption tower is conveyed via one of the lines 14, 15, 16 and 17 and line 3 into the combustion chamber B.

Gas formed in B and regeneration offgas which are not required are conveyed as off gas (VII) via lines 18 and 19 to the stack (K). The mixture of gas formed in B and regeneration offgas which leaves G after cooling is conveyed as offgas via lines 19 and 18 to the stack.

Experimental Part

1. Deactivation of the Catalyst

A fresh feed was fed continuously at a flow rate of 1570 g of fresh feed/kg of catalyst/h into a reactor provided with 480 g of a catalyst bed of Re₂O₇/Al₂O₃ (freshly prepared by impregnation of the Al₂O₃ extrudates in aqueous perrhenic acid and subsequent calcination by methods known from the literature) for a period of 10 days. The composition of the fresh feed was: 46% of 1-butene, 33% of 2-butene, 15% of n-butane, remainder 6%. In addition, 1% of ethylene was mixed into the feed in order to achieve a further increase in the propane yield. The fresh feed was passed through a guard bed comprising 280 g of 13× molecular sieves to remove oxygen-containing compounds from the feed.

To increase the C₄ conversion, unreacted C₄ and C₅ constituents of the output from the reactor were either partly or wholly recirculated to the reactor inlet and mixed with the fresh feed.

The activity of the catalyst was examined by way of example in the production of propene (determination at the outlet of the reactor). The values reported are in each case on-line GC measurements averaged over 24 hours.

| Day 1 | Day 2 | Day 3 | . . . | Day 9 | Day 10 |
|---|---|---|---|---|---|
| 14.3% | 13.7% | 14.3% | . . . | 12.5% | 10.8% |

After the propene production had dropped to 10.8% (day 10), the experiment was stopped and the catalyst was regenerated.

2. Regeneration of the Deactivated Catalyst (According to the Present Invention)

### EXAMPLE 2a

480 g of catalyst (deactivated as under 1) was heated from 100 to 550° C. over a period of 6-12 hours in a continuous N₂ stream of 45 l/h until the residual content of CO and CO₂ had dropped below 500 ppm. No temperature increases in the reactor were observed (compensation of exothermic carbon oxidation by endothermic Re reduction). After the final temperature (550° C.) had been reached, air was added to the N₂ at a rate increasing from 0 to 2.5 l/h over a period of 4 hours (O₂ content: 1.1% by volume). After 6 hours, the 2.5 l/h of air was doubled (5 l/h). The O₂ content at the inlet of the reactor was then measured as 2.1% by volume. The burn-off procedure was continued until the O₂ concentrations at the inlet and outlet of the reactor were the same (difference <500 ppm). This was the case after two hours. The burn-off phase was continued for a further two hours. The temperature increases observed were not more than 50° C. The catalyst was subsequently cooled in a stream of N₂.

Total regeneration time: about 24-30 h, maximum temperature observed 560° C.

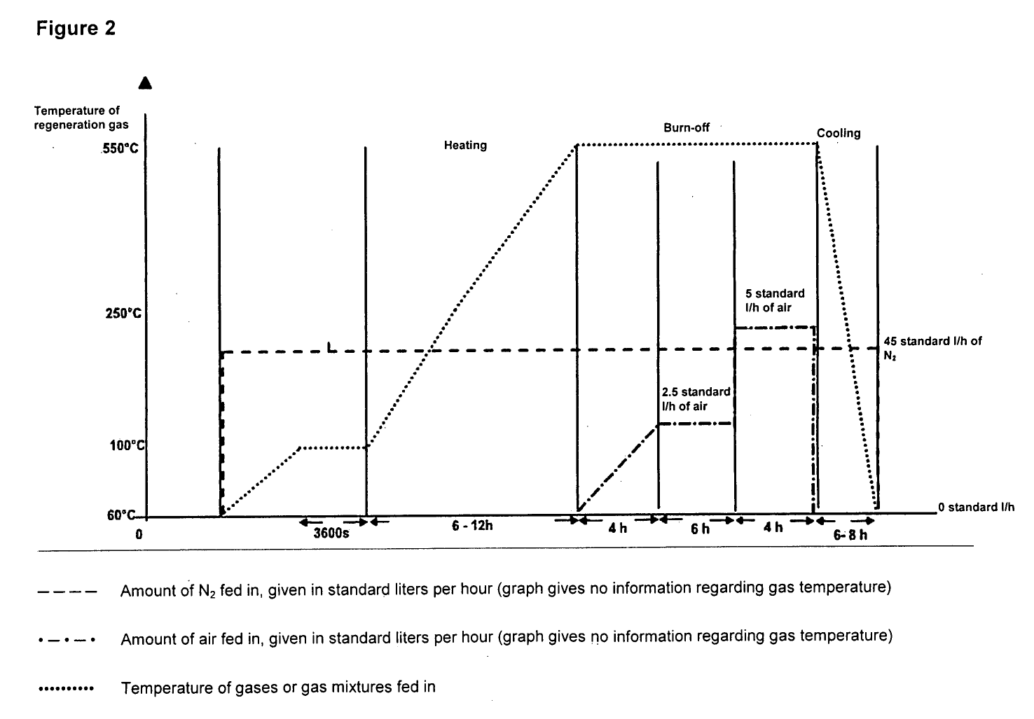

This regeneration procedure is depicted in FIG. 2 for the purposes of illustration.

### EXAMPLE 2b

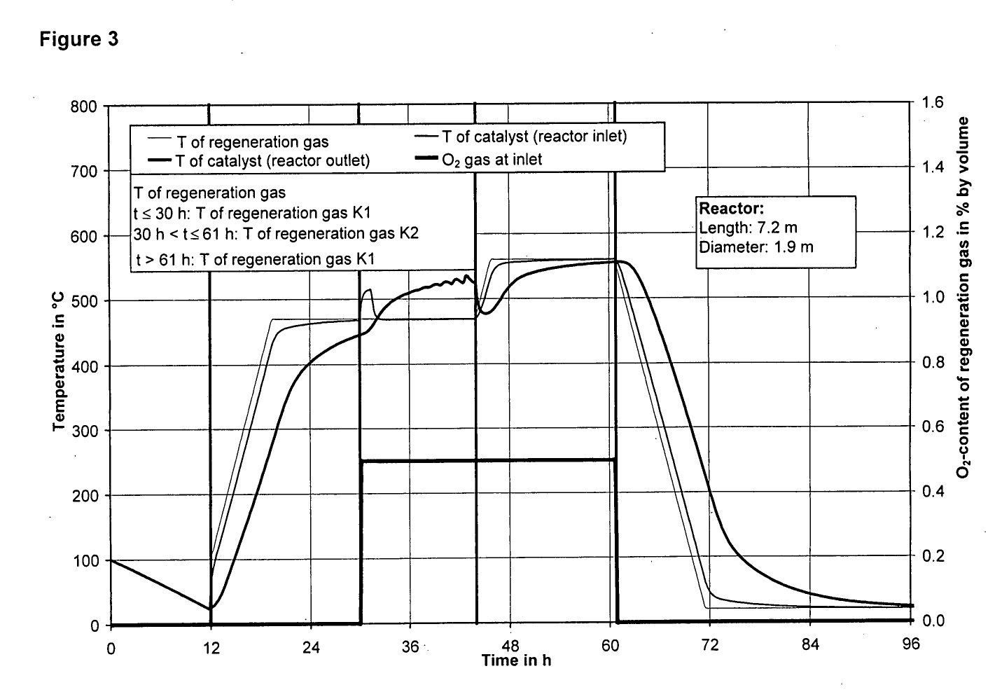

Example 2a was repeated on an industrial scale. The experimental conditions are shown in FIG. 3.

3. Renewed Use of the Catalyst Regenerated According to the Present Invention

After the regeneration was complete, the catalyst which had been regenerated as described under 2a was again taken into operation under the conditions specified under 1.

The activity of the catalyst was examined by way of example in the production of propene (determination at the outlet of the reactor in two series of parallel measurements). The figures reported are in each case on-line GC measurements averaged over 24 h.

| Day 1 | Day 2 | Day 3 | . . . | Day 9 | Day 10 |
|---|---|---|---|---|---|
| 14.4% | 15.0% | 14.2% | . . . | 12.5% | 11.3% |
| 15.4% | 15.2% | 14.6% | | 13.6% | 10.5% |

It can be seen that the behavior of the regenerated catalyst is virtually indistinguishable from that of freshly prepared catalyst.

4. Regeneration of the Deactivated Catalyst by Methods of the Prior Art

### Examples of Various Regeneration Procedures

The following examples illustrate the influence of the regeneration procedure employed on the time taken for the procedure and the generation of internal temperatures in the reactor.

All examples were carried out using catalysts which had been deactivated by the treatments described in the above examples.

### Comparative Example 4a

Regeneration of a deactivated catalyst according to the prior art (addition of air during the heating phase)

480 g of catalyst were heated in a gas stream consisting of 45 l/h of N₂ and 5 l/h of air (O₂ content: 2.1% by volume), with the gas stream being heated up to 550° C. over a period of 12 hours by means of a preheater. The internal temperature of the reactor was monitored by means of a thermocouple. As a result of the simultaneous processes or carbon oxidation and rhenium oxidation, local hot spots of up to 900° C. (depending on the amount of carbon present) occurred in the reactor above an ignition temperature of about 300° C. (temperature of the regeneration gas entering the reactor). After no further temperature increases caused by burn-off processes were observed (time: about 24 h) and the output temperature of the reactor was equal to the inlet temperature (550° C.), the temperature was maintained at 550° C. for a further six hours to ensure complete reoxidation of the rhenium. The catalyst was then cooled in a stream of N₂.

Total regeneration time: 24-30 h, maximum internal temperature in the reactor: 900° C. At such an internal temperature in the reactor, virtually all materials of construction are irreversibly damaged. In addition, rhenium begins to sublime from the catalyst particles at this temperature, which after the regeneration procedure had been carried out a number of times led to an appreciable reduction in the rhenium content and thus to decreasing activities and cycle times (time after which regeneration of the catalyst became necessary).

### Comparative Example 4b

Regeneration of a deactivated catalyst according to the prior art (slow addition of air/heating phase with a low O₂ content)

480 g of catalyst were heated to 100° C. in an N₂ stream of 45 l/h. After the final temperature (100° C.) had been reached, 1.0 l/h of air were added to the N₂ (0.5% by volume of O₂). The temperature of the regeneration gas was then increased at about 20-25° C./h. When the first ignition phenomena occurred, the temperature was firstly maintained (12 h, temp. about 350° C.). After no further temperature increases due to burn-off processes were observed, the temperature was increased at a slower rate of 10° C./h to 550° C. (time taken: 20 h). The temperature increases observed were no more than 60-80° C. The temperature was maintained at 550° C. for a further six hours. The catalyst was then cooled in a stream of N₂.

Total regeneration time: about 55-60 h, maximum internal temperature in the reactor: 60° C.

1. A method of regenerating an Re₂O₇-doped supported catalyst which has been deactivated by use in the metathesis of a hydrocarbon mixture comprising C₂-C₆-olefins (C₂₋₆⁼ feed) (deactivated catalyst), which comprises:
treating the deactivated catalyst with an inert gas (regeneration gas K1) at from 400 to 800° C.; and
subsequently treating the deactivated catalyst which has been pretreated with regeneration gas K1 with an oxygen-containing gas (regeneration gas K2).

2. A method as claimed in claim 1, wherein a deactivated catalyst by means of which the metathesis has been carried out by passing the C₂₋₆⁼ feed in the liquid phase through a catalyst bed comprising a freshly prepared or regenerated Re₂O₇-doped supported catalyst at from 10 to 150° C. and a pressure of from 10 to 100 bar at a flow rate of 0.1-1000 liters per kg per hour for from 1 to 1000 hours and subsequently separating the catalyst from the C₂₋₆⁼ feed and the products formed in the metathesis is used.

3. A method as claimed in claim 1 or 2, wherein the metathesis is carried out using a C₂₋₆⁼ feed which is obtained by freeing a C₂₋₆⁼ feed comprising oxygen compounds of the oxygen compounds by passing it through a guard bed comprising high-surface-area aluminum oxides, silica gels, aluminosilicates or molecular sieves.

4. A method as claimed in claim 1 or 2, wherein the metathesis is carried out using a C₂₋₆⁼ feed comprising 1- or 2-butene as main component.

5. A method as claimed in claim 1 or 2, wherein the treatment of the deactivated catalyst with regeneration gas K1 is continued until the formation of CO₂ and CO has largely stopped.

6. A method as claimed in claim 1 or 2, wherein the treatment of the deactivated catalyst with regeneration gas K1 is carried out by passing the regeneration gas K1 through a catalyst bed of the deactivated catalyst at a gas velocity of from 10 to 500 liters per kg per hour.

7. A method as claimed in claim 1 or 2, wherein the treatment of the deactivated catalyst with regeneration gas K1 is carried out by increasing the gas temperature from an initial gas temperature of 40-150° C. at a rate of from 50 to 100° C./h.

8. A method as claimed in claim 1 or 2, wherein the treatment of the deactivated catalyst which has been pretreated with regeneration gas K1 with the regeneration gas K2 is continued until the oxygen content of the regeneration gas K2 undergoes virtually no further change during the treatment.

9. A method as claimed in claim 1 or 2, wherein the treatment of the deactivated catalyst which has been pretreated with regeneration gas K1 with the regeneration gas K2 is carried out by passing the regeneration gas K2 at a gas space velocity of 50-500 liters per kg per hour through a catalyst bed of the deactivated catalyst which has been pretreated with regeneration gas K1.

10. A method as claimed in claim 1 or 2, wherein the regeneration gas K1 is a gas which is selected from the group consisting of nitrogen, noble gases and gas mixtures of nitrogen and noble gases and may further comprise up to 10% of CO₂ or up to 40% of a saturated C₁-C₆-hydrocarbon.

11. A method as claimed in claim 1 or 2, wherein the regeneration gas K1 is a mixture consisting essentially of:
from 50 to 100% of a gas selected from the group consisting of nitrogen, noble gases and gas mixtures of nitrogen and noble gases;
if desired, up to 0.1% of oxygen; and
if desired, up to 10% of CO₂ or up to 40% of a saturated C₁-C₆-hydrocarbon.

12. A method as claimed in claim 1 or 2, wherein the regeneration gas K2 is a mixture consisting essentially of:
from >0.1 to 100% of oxygen
from 50 to 99.9% of a gas selected from the group consisting of nitrogen, noble gases and gas mixtures of nitrogen and noble gases; and
if desired, up to 10% of CO₂ or up to 40% of a saturated C₁-C₆-hydrocarbon.

13. A method as claimed in claim 1 or 2, wherein the regeneration of the deactivated catalyst (regeneration phase K) and the metathesis which causes deactivation of the catalyst (metathesis phase) are carried out alternately in the reactor.

14. A method as claimed in claim 13, wherein the metathesis phase and the regeneration phase K are carried out simultaneously by providing a system of reactors and carrying out the regeneration phase K in one reactor while carrying out the metathesis phase in another reactor.

15. A method as claimed in claim 14, wherein the metathesis phase and the regeneration phase K are carried out simultaneously by providing a system of 3 or more reactors which are alternately operated in the metathesis phase and the regeneration phase K, with the reactor which has been in the metathesis phase for the longest time is selected for the change of a reactor from the metathesis phase to the regeneration phase K.

16. A method as claimed in claim 3, wherein a deactivated guard bed which has been deactivated by the treatment of the C₂₋₆⁼ feed comprising oxygen compounds as set forth in claim 3 is regenerated by:
treating the deactivated molecular sieves with an inert gas (regeneration gas M1) at flow rates of 1-2000 l/(kg*h) and a temperature of from 100 to 350° C. for 12-48 hours (regeneration phase M1); and
if desired, subsequently treating the deactivated molecular sieves which have been pretreated with inert gas with an oxygen-containing gas mixture (regeneration gas M2) at flow rates of 1-2000 l/(kg*h) for 12-48 hours.
